(19) United States
(12) Patent Application Publication
(10) Pub. No.: US 2003/0135410 A1
(43) Pub. Date: Jul. 17, 2003

(54) Offer system and method

(75) Inventors: Dean Chapman, London (GB); Jerome Gudgeon, Surrey (GB); Ben Hockham, Herts (GB)

Correspondence Address: SNELL & WILMER, ONE ARIZONA CENTER, 400 EAST VAN BUREN, PHOENIX, AZ, 850040001

(73) Assignee: AMERICAN EXPRESS TRAVEL RELATED SERVICES COMPANY, INC., NEW YORK, NY

(21) Appl. No.: 10/122,850

(22) Filed: Apr. 12, 2002

Related U.S. Application Data
(60) Provisional application No. 60/347,748, filed on Jan. 11, 2002.

(51) Int. Cl. G06F 17/60

(52) U.S. Cl. 705/14

(57) ABSTRACT

An offer system and method that enables offers or the creation of offers with conditions and rewards and may be computer implemented. Actions of customers are tracked and whether conditions have been met are determined and rewards allocated in accordance with the offers. Steps may include, for example, facilitating trading, charging commissions, tracking customer actions, and adjusting commissions charged based on the quantity of trading, e.g. of stock, within a preceding period of time. Rewards may be enabled by the next day from when the conditions for the rewards are completed. Mandatory conditions and optional conditions may be accommodated, and a plurality of offers may be evaluated for various customers, which may include determining the best offer under the circumstances for each customer. Communication with at least some of the customers may be via the Internet or cellular telephony.

### RELATED APPLICATIONS

This invention claims priority to U.S. provisional application No. 60/347,748, entitled “OFFERS SYSTEM AND METHOD,” filed on Jan. 11, 2002 which is incorporated herein by reference.

### FIELD OF INVENTION

This invention relates generally to offers, and more particularly, to systems and methods that track or manage offers.

### BACKGROUND OF THE INVENTION

Previously, most systems and methods that track or manage offers applied one offer to all new or existing customers without the ability to run several offers simultaneously. Moreover, in the past, most offer systems relating to, for example, stock trading, would include commission systems that would reach the end of quarter and then rebate commissions retrospectively. Accordingly, a need exists for an offer system and method that can run several offers simultaneously or provide rewards, such as lowering commissions, without delay, for example when certain conditions have been met. In particular, a need exists for such a system related to facilitating trading, and even more specifically, to facilitating trading of stocks. Other needs also exist which may be known in the art or may be apparent from the disclosure herein.

### SUMMARY OF THE INVENTION

In at least partial fulfillment of these and other needs, the present invention provides an offer system and method that can run several offers simultaneously or provide rewards, such as, for example, lowering commissions when certain conditions have been met. Rewards may also be provided the day after the conditions are met. In an exemplary embodiment, the present invention provides a system and method that facilitates trading, or works in conjunction with another system or method that facilitates trading. The system tracks customer activities (e.g. trading) and enables or provides rewards based on the activities, for example, reducing commissions for facilitating trading when the quantity of trading in a previous time period exceeds a particular amount.

More specifically, an exemplary embodiment of the present invention provides an offer system that includes a processor and a storage device. The system may be configured to enable a plurality of offers, which may have at least one condition and at least one reward. The system may track actions of the customers, including, for example, activities regarding the conditions. The system may also determine whether the conditions have been met and allocate the rewards in accordance with the offers when the conditions have been met. In a specific embodiment, the system may enable, as an example, offers that have a reward that includes facilitating trading.

In various further embodiments, the system may be configured to accommodate mandatory conditions, optional conditions, or both. Where applicable, a commission may be charged for the facilitating trading (e.g. of stock), and the reward may include lowering the commission. The system may, as an example, be configured to lower the commission within 24 hours of when the conditions are met, and the condition may include a quantity of trading within a preceding period of time. In some embodiments, the system may be configured to evaluate a plurality of offers for various customers, which may include determining the best offer under the circumstances for each customer. The system may then, as an example, allocate the reward in accordance with the best offer for each customer. The system may be configured to communicate with the customers via various networks, such as the Internet, a cellular telephone network, or both.

In another exemplary embodiment, the present invention provides a method of facilitating, which may involve using a computer. The service that is facilitated may be trading, and a commission may be charged for this service. The method may further include the step of tracking the facilitating, which may also involve using a computer. The method may even further include adjusting, for example, the commission, which may occur at the time the commission is charged, and may be based on the quantity of trading within a preceding period of time. As an example, the commission may be reduced per trade when there is an increase in the quantity of trading.

The present invention also provides methods that may include the step of enabling the creation of offers, and may be configured to enable offers having various numbers of conditions and rewards. The method may include evaluating the offers, which may include considering any conditions, considering any rewards, and may involve favoring more frequent trading. The method may also include tracking the actions of customers, which may involve storing (e.g. on a computer) information regarding the actions of the customers regarding the conditions of the offers. The method may further include the steps of determining whether the customers have completed the conditions, and making the rewards available to the customers, for example, by the next day from when the conditions for the rewards are completed.

### BRIEF DESCRIPTION OF THE DRAWINGS

FIG. 1 is a block diagram illustrating an example of a system in accordance with the present invention and an environment in which the system may operate;

FIG. 2 is a flow chart illustrating the steps of an exemplary method in accordance with the present invention;

FIG. 3 is another block diagram illustrating an example of an offer system and a trader system in accordance with the present invention and an environment in which the systems may operate;

FIG. 4 is another flow chart illustrating the steps of an exemplary method in accordance with the present invention; and,

FIG. 5 is another flow chart illustrating the steps of another exemplary method in accordance with the present invention.

### DETAILED DESCRIPTION

The figures include block diagrams, various components and flow charts illustrating various steps of various exemplary embodiments of the present invention. Embodiments of systems in accordance with the present invention may contain, inter alia, components from one or more of these drawing figures that may be configured to perform steps from one or more of the drawing figures. Embodiments of methods in accordance with the present invention may contain, inter alia, steps from one or more of these drawing figures.

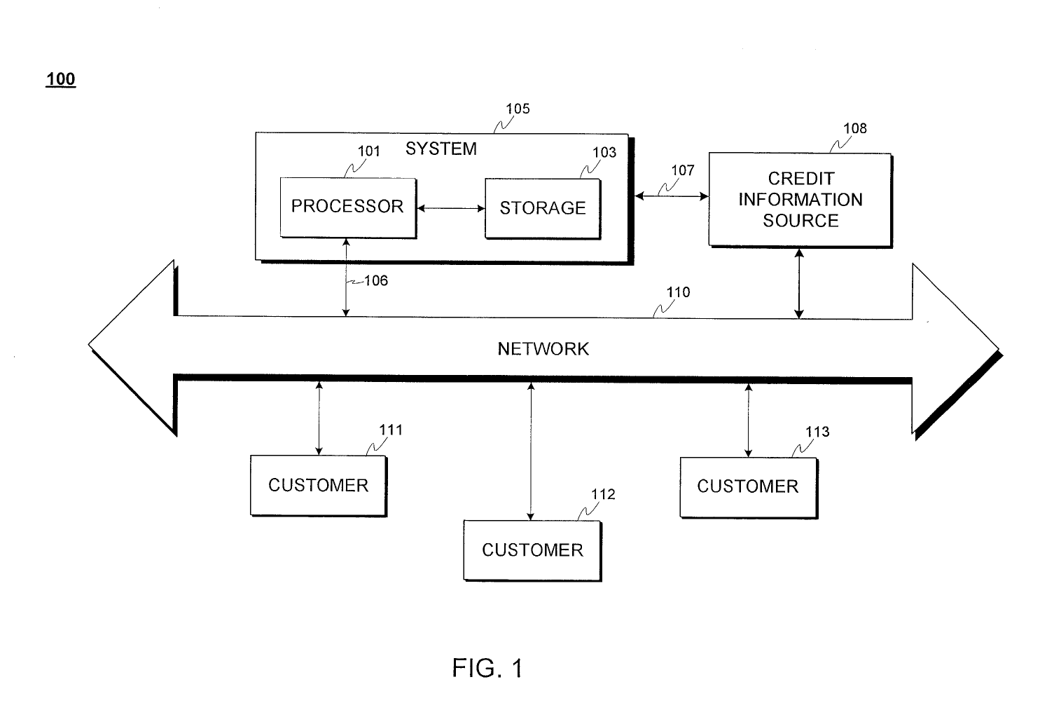

FIG. 1 illustrates an exemplary embodiment of a system 105 in accordance with the present invention and an example of an environment 100 in which system 105 may operate. System 105 may include a host server or other computing system which may include a processor 101, for instance, for processing digital data and a memory or storage 103 for storing digital data coupled to processor 101. Embodiments of the present invention may also include an input digitizer coupled to processor 101 for inputting digital data, an application program which may be stored in storage 103 and accessible by processor 101 for directing processing of digital data by processor 101, a display coupled to processor 101 and storage 103 for displaying information derived from digital data processed by processor 101, and a plurality of databases (e.g. stored in storage 103). These databases may include client data, merchant data, financial institution data and/or (any combination of one or more) like data that could be used in association with the present invention.

Customers 111, 112, and 113 (as examples) may each have a device to access network 110, and the device may be or include a computer. As those skilled in the art will appreciate, a user or customer computer will typically include an operating system (e.g., Windows NT, 95/98/2000, Linux, Solaris, etc.) as well as various conventional support software and drivers typically associated with computers. A user computer (e.g. used by customer 111, 112, or 113) can be in a home or business environment with access to network 110 which may be the Internet. In other words, access to the present invention, (e.g. to system 105) may be through the Internet, for instance, through a commercially-available web-browser software package. Various embodiments of the present invention, however, may utilize other networks 110. In general, communication between the parties to a transaction (e.g. between customer 111 and system 105) may be accomplished through any suitable communication network 110, such as, for example, a telephone network, Intranet, Internet, point of interaction device (point of sale device, personal digital assistant, cellular phone, kiosk, etc.), online communications, off-line communications, wireless communications, and/or the like.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The database (e.g. stored in storage 103) may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access by Microsoft Corporation (Redmond, Wash.), or any other database product. The database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. Data tables having similar, though not identical, data in the key fields, however, may also be merged by using AGREP, for example.

Still referring to FIG. 1, in various embodiments of the present invention, the computer or server (e.g. system 105) may provide a suitable website or other Internet-based graphical user interface, which is accessible by users or customers (e.g. 111, 112, and 113). In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access Sequel Server, Oracle, MySQL, Intervase, etc., may be used to provide an ADO-compliant database management system. The term “webpage” as it is used herein is not meant to limit the type of documents and applications that might be used to interact with the user (e.g. customer 111). For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

It should be appreciated that functional blocks used herein to describe the present invention may be realized by any number of hardware and/or software components configured to perform the specified functions. For example, the present invention may employ various integrated circuit components, e.g., memory elements, processing elements, logic elements, look-up tables, and the like (e.g. storage 103), which may carry out a variety of functions under the control of one or more microprocessors or other control devices (e.g. processor 101). Similarly, the software elements of the present invention may be implemented with any programming or scripting language such as C, C++, Java, COBOL, assembler, PERL, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may comprise features to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

System 105 may be suitably coupled to network 110 via data links 106. A variety of conventional communications media and protocols may be used for data links 106. Such as, for example, a connection to an Internet Service Provider (ISP) over the local loop as is typically used in connection with standard modem communication, cable modem, Dish networks, ISDN, Digital Subscriber Line (DSL), or various wireless communication methods. System 105 might also reside within a local area network (LAN) which interfaces to network 110 via a leased line (T1, D3, etc.).

As used herein, the term “end user”, “consumer”, or “customer” (e.g. customers 111, 112, or 113), may be used interchangeably with each other, and each shall mean any person, entity, machine, hardware, software or business that may be interested in doing business, for instance, with business 345, for example, via trader system 343, offer system 341, or both. It is further noted that other participants may be involved in some phases of the transaction, such as an intermediary settlement institution, but these participants may not be shown. A merchant computer or a bank computer may be interconnected via a second network, which may be a payment network (e.g. 107). The payment network 107 may be a proprietary network that accommodates transactions for credit cards, debit cards, and other types of financial/banking cards. The payment network 107 may be a closed network that may be secure from eavesdroppers. Examples of the payment network 107 include the American Express®, VisaNet® and the Veriphone® network.

Customers (e.g. 111, 112, and 113) may have accounts that may be identified by account numbers. An “account number”, as used herein, includes any device, code, or other identifier/indicia suitably configured to allow the consumer (e.g. 111) to interact or communicate with the system 105, such as, for example, authorization/access code, personal identification number (PIN), Internet code, password, other identification code, and/or the like which may be located on a card, for example, possessed by customer 111. The card may be a rewards card, charge card, credit card, debit card, prepaid card, telephone card, smart card, magnetic stripe card, bar code card, radio frequency card, and/or the like. The account number may be distributed and stored in any form of plastic, electronic, magnetic, radio frequency, audio and/or optical device capable of transmitting or downloading data from itself to a second device. A customer account number may be, for example, a sixteen-digit credit card number, although each credit provider may have its own numbering system, such as the fifteen-digit numbering system used by American Express. Each company's credit card numbers may comply with that company's standardized format such that the company using a sixteen-digit format may use four spaced sets of numbers, as represented by the number “0000 0000 0000 0000”. The first five to seven digits may, for example, be reserved for processing purposes and identify the issuing bank, card type, etc. In this example, the last or sixteenth digit may be used as a sum check for the sixteen-digit number. The intermediary eight-to-ten digits may be used to uniquely identify the customer (e.g. 111).

It should be appreciated that the particular implementations shown and described herein are illustrative of the invention and include its best mode known to the inventors, but are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present, for example, in a practical electronic transaction system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code embodied in the storage medium (e.g. storage 103). Any suitable computer-readable storage medium may be utilized (e.g. in storage 103), including hard disks, CD-ROM, optical storage devices, magnetic storage devices, and/or the like.

The present invention is described herein with reference to block diagrams (e.g., systems) and flowchart illustrations of methods according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus (e.g. processor 101) to produce a machine or system (e.g. 105), such that the instructions which execute on the computer or other programmable data processing apparatus are configured to perform the functions specified in the flowchart block or blocks.

Referring still to FIG. 1, as examples of various steps that may be performed, queries from a customer (e.g. 111, 112, or 113) may be accepted by the system 105. The system 105 may solicit any necessary information or customer data from the customer (e.g. 111), and data may be exchanged with the system 105. In addition, if in response to the information received the customer (e.g. 111) elects to make a credit card or debit card purchase of goods or services, for example, a purchase of stock, a credit check may be requested from a credit information source 108. Further, on credit approval, the requested goods or services (e.g., stock certificates) may be dispensed (or a document providing proof thereof) in consideration for customer's payment by credit card or other form of payment, and information on the transaction may be transmitted to the relevant company's (e.g., the company selling the stock) data source. Communication may be via one or more networks (e.g. network 110), which, as described above, may include the Internet. Credit information source 108 may be contacted via the same or a separate network (e.g. 107), which may have various security features. In other words, the system 105 may be suitably and securely interfaced to a credit card payment gateway (e.g. 107 and/or 108) for accepting payments from a customer 111 in response to an instruction to purchase. Such a system and method can, for example, be used in the stock trading industry.

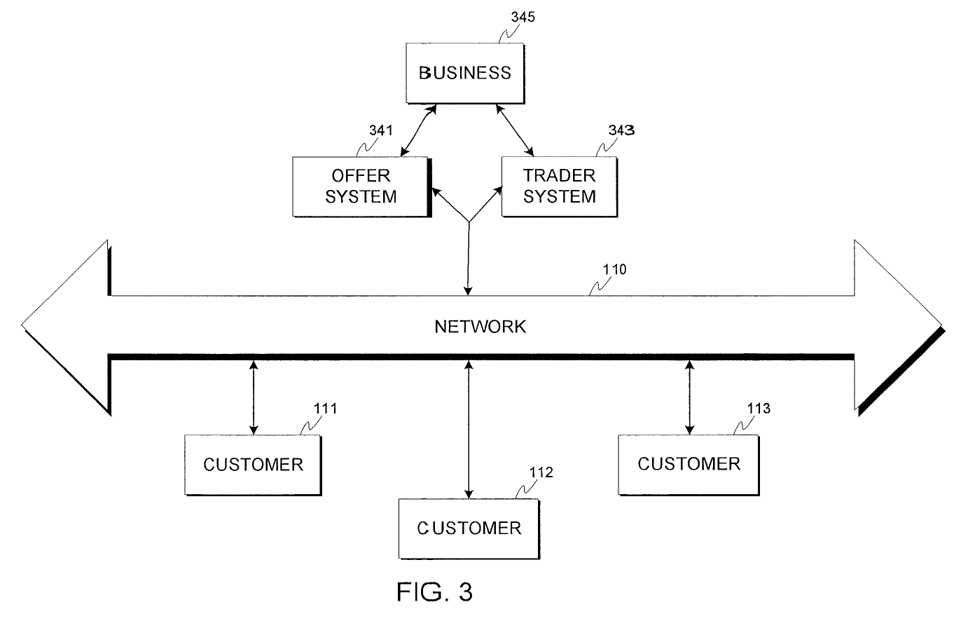

Introducing FIG. 3, in one exemplary embodiment of the present invention, an offer system 341 may work in conjunction with a trader system 343, which may facilitate the process for the offer to be given to the public (e.g. to customers 111, 112, and/or 113). And, trader system 343 (e.g., a frequent trader system) may include, as a specific function of the offer system 341, a commission schedule that may reward frequent trading. The system (e.g. offer system 341, trader system 343, or both) may, in an exemplary embodiment, examine prior data dynamically, over a rolling 90 day period (or any number of days and the period may be adjustable) in order to change current trading commissions according to the frequency of previous trades (e.g. the greater the number of trades, the lower the commission). As such, the system (e.g. offer system 341 and/or trader system 343) may allow the customer (e.g. 111) to immediately (or within a short time, for example, by the next day) experience the impact of (e.g. benefit from) the change (e.g. lowering) in the commission rate. Offer system 341 and/or trader system 343 may be utilized by and/or operated by a business 345. Business 345 may, for example, derive income from commissions charged for facilitating purchasing and/or sale of stock for customers (e.g. 111,112, and/or 113).

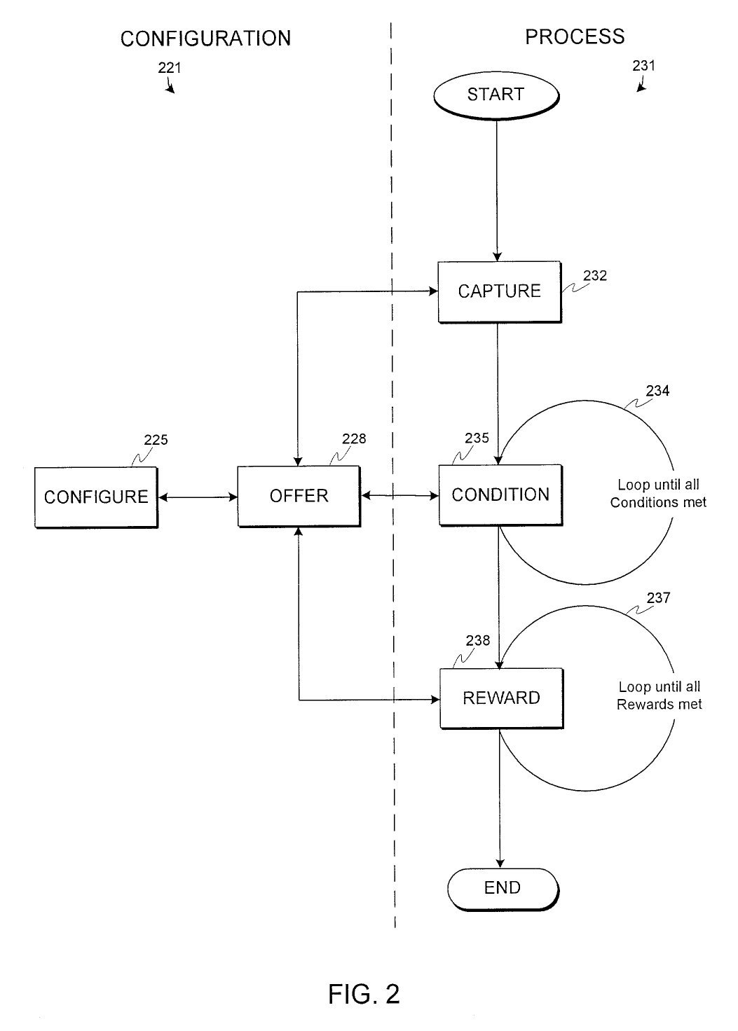

Referring also to FIG. 2, business 345 may require or want an offer system 341 to support cross-channel offers (e.g. offers 228), and to track those offers (e.g. 228) in order to judge relative worth. Among other things, the following paragraphs outline and provide detailed information on how offer system 341 may, at least in part, fulfill those requirements and desires.

Thus, in an exemplary embodiment, the present invention includes an offer system (e.g. 341 or 105) that calculates the best offer 228 to apply to an account (e.g. of customer 111, 112, or 113) by enabling the creation of an offer 228, with none, one or more conditions 235. The conditions 235 may include mandatory or optional conditions such as: open an account, trade X times, transfer shares or money, etc. For example, staff commissions at one organization (e.g., a business 345) may be less than the commissions from the frequent trader system (e.g. 343), so even if a staff member qualifies for frequent trader commissions, system 341 may prevent the offer (e.g. 228) from being applied to the staff member; and instead apply the lower commission charge as a reward (e.g. 238) to the staff member. System 341 may prevent the offer (e.g. 228) from being applied to the staff member by evaluating commission priorities, which may have been previously configured. When the offer (e.g. 228) is added to the customer's (e.g. customer 111, 112, or 113) financial account (charge card account, etc.), the offer system (e.g. 341 or 105) may keep track of the actions of the customer (e.g. customer 111, 112, or 113) to determine if the customer completes the condition(s) (e.g. 235). As such, the offer system (e.g. 341 or 105) may suitably track numerous offers (e.g. 228) simultaneously. Upon completion, the system (e.g. 341 or 105) may create a reward (e.g. 238) for the customer (e.g. 111, 112, or 113). Rewards 238 may include, for example, money from the system (e.g. 341, 343, or 105), free trades (e.g. via trader system 343), loyalty points, etc. Moreover, in various embodiments of the present invention, an audit trail may be created for the customer (e.g. 111, 112, or 113). The audit trail may be created, for example, by storing (e.g. in storage 103) condition data (e.g. data regarding or pertinent to whether condition or conditions 235 have been met), reward data (e.g. data regarding or pertinent to whether reward or rewards 238 have been met), and offer data (e.g. data regarding or pertinent to offer or offers 228) against the customer (e.g. 111). In other words, the various types of data may be sorted and stored according to which customer (e.g. 111) the data pertains to. This data may, for example, be printed out or downloaded if needed or desired.

The present invention (e.g. system 105) may include a web-based front office system that may be a JAVA-based system that may create the web pages dynamically. It may also be the primary front office tool used by customer contact staff, for instance, of business 345. The present invention (e.g. system 105) may also have a back office system that may be, for example, IBM-based. The back office system may be the trading transaction system (e.g. trader system 343), and as such may also be the main interface for other back office systems (e.g., bank accounts, e.g. via payment network 107).

The business 345 may need or desire to be able to offer their customers (e.g. 111, 112, and/or 113) a range of offers 228 in order to draw customers (e.g. 111, 112, and/or 113) to business 345 (or to trader system 343) and their products or services. The offers 228 may be global, or may be restricted to certain channels (e.g. of advertising). Offers 228 may be given to individuals, or groups of individuals (e.g. customers 111, 112, and/or 113), on an ad hoc basis. The channels may include, for example: newspaper advertisements, telesales, direct marketing, and web advertisements, and the offers may be defined by the business 345. Different commissions may be charged, for example, to different customers (e.g. a higher commission to customer 111 than to customer 112), based on where the customers (e.g. 111 and 112) look for offers. Accordingly, when market research, as an example, indicates a correlation between where customers look for offers and how much commission they are willing to pay, the system (e.g. 105 or 341) may increase profits (e.g. of business 345 or trader system 343) by charging each customer (e.g. 111 and 112) the highest commission that they are individually, or as a group, willing to pay (or, for at least some customers, e.g. 111, higher than they would otherwise have to pay). In other situations, it may be desirable to charge different customers (e.g. 112 and 113) different commissions, for example, because greater expenses (e.g. per commission earned) may be incurred in servicing one customer (e.g. 112) than another (e.g. 113), for instance, where customer 113 trades in a higher volume (paying more commissions) than customer 112.

The business 345 may require or desire a system (e.g. 105 and/or 341) to provide it the ability to create, for example, a wide range of offers 228 for the customer base (e.g. customers 111, 112, and/or 113). The system (e.g. 105 or 341) may need to be flexible enough to configure new offers (e.g. 228) in a short time scale and on an ad hoc basis. Thus, the system (e.g. 105 or 341) may be configurable to create offers 228 on a global, group or individual basis, allow customers (e.g. 111, 112, and/or 113) to each have none, one or many offers 228, and allow offers 228 to have none, one, or many conditions 235 that must be met before the customer (e.g. 111) qualifies for the offer 228. Creation of offers 228 on a global basis may include adding the offer 228 on a non-specific basis (e.g. to any customer 111, 112, or 113 that applies or responds to the offer 228). Creation of offers 228 on a group basis may include adding the offer 228 to a particular type of customer (e.g. customers 112 and 113 who may be, for instance, customers who access system 105 or 341 via the Internet or through a particular web page on the Internet). Creation of offers 228 on an individual basis may involve adding offers 228 that are specific to one customer (e.g. 113) and may be unique to that particular customer.

In various exemplary embodiments, the conditions 235 may be: mandatory conditions (AND conditions) or optional conditions (OR conditions). Some embodiments allow offers 228 to comprise none, one or many rewards 238 to the customer (e.g. 111, 112, or 113), which may be through a variety of channels. Various embodiments may provide reporting that will enable the business (e.g. 345) to monitor the success of individual offers 228, add on new components (such as new conditions 235 or rewards 238), eliminate conditions, and the like, which may require only a minimum amount of effort. Various embodiments of the present invention may include any combination of these features.

Referring primarily to FIGS. 2 and 3, the following will describe the initial conditions 235 and rewards 238 the business 345 may require or desire. Please note that part of the requirements or components could be added to the system (e.g. 105, 341, or 343) at a later date (e.g. well after the system 105, 341, or 343 is first put into operation). Not only that, but these lists are not intended to be an exhaustive list of conditions 235 or rewards 238 that may be available with an offer system (e.g. 341) according to the present invention. That being said, in an exemplary embodiment, where x signifies any number, the customer's (e.g. 111) conditions (e.g. 235) may include that the customer must (in order to receive one or more rewards 238), for instance: open an account, trade x times, transfer x funds into a bank account, or transfer x value of shares into a portfolio. The customer's (e.g. 111) rewards (e.g. 238) may include that the business 345 or system 341, for example, will: pay x funds into the customer's (e.g. 111) bank account, give the customer (e.g. 111) x free trades, give the customer (e.g. 111) x membership reward (MR) points, or the like.

Taking a look at FIG. 2 in more detail, a high level view of the implementation of an exemplary embodiment of the offer system 341 is shown. The area 231 indicates the process that the customer (e.g. 111, 112, or 113) travels through, whilst the area 221 indicates the configuration processes (setting up static data that defines the offer 228). The following text looks at exemplary embodiments of each process in turn and describes what they may be. The customer (e.g. 111, 112, or 113) processes 231 are discussed first. The customer processes 231 may assume that the offer 228 has already been set up. If it hasn't, the process 231 may end with the capture 232 of the offer code. The offer code may be added to the customer's (e.g. 111, 112, or 113) account in order that the customer may obtain the offer 228. Once the offer 228 is added, the system 341 may then check on a regular basis (loop 234) to see if the customer (e.g. 111, 112, or 113) has met the conditions 235 of the offer 228 and if they (e.g. customer 111, 112, or 113) should be rewarded (in step 238).

Although the customer (e.g. 111) may be able to enter data into the system 341 by many various interfaces, ultimately someone (e.g. customer 111 or an agent thereof) may enter the customer details into the system 341 through the application process. System 341 may utilize offer codes, which may be short or long, an exemplary embodiment of which is described in more detail below. In one embodiment, an offer code may be given to the customer (e.g. 111) (or agent, as the case may be) in a long offer code format. The system 341 may validate that the long offer code is in the correct format, and then may store a short offer code against the customer (e.g. 111).

Periodically, for example every night, system 341 may run one or a series of programs to check all the actions done on system 341 that might be part of an offer 228. When it finds them, system 341 may check to see if the customer (e.g. 111) who took that action has an offer (e.g. 228). If they (e.g. customer 111) have, it (e.g. system 341) may check the offer 228 to see if there is a condition 235 waiting to be fulfilled that matches the action.

Finally, system 341 may check (e.g. in step 234) to see if the action completely fulfills the condition 235 (for example, a transfer in the amount of $100 would not fulfill a condition 235 to transfer an amount of $1000). If the condition 235 is completed, system 341 may then check to see if the customer (e.g. 111) has completed all their conditions 235 for that offer 228 (e.g. in step 234). If they have, system 341 may flag them (e.g. customer 111) to receive a reward 238. In some embodiments of the present invention, there may be no conditions 235 required to satisfy an offer 228. In those situations, the program may automatically flag those customers (e.g. 111, 112, and 113) to receive a reward 238.

After the condition programs (e.g. step 234) have been run by system 341, the system may then run the reward programs (e.g. step 237). These check to see which customers (e.g. 111) have been flagged as needing (met the conditions 235 for) a reward 238. When a customer (e.g. 111) needs a reward 238, system 341 may check the offer 228 to determine the type of reward(s) 238. System 341 then may give that reward 238 to the customer (e.g. 111). For example, if reward 238 is a cash amount, system 341 may ask a back office system to transfer (e.g. via payment network 107) the appropriate amount of funds from a company (e.g. business 345) account to the customer's (e.g. 111) account. This means that the reward 238 can usually be given at least within a day (e.g. within 24 hours, or by the next business day) or two of the offer 228 conditions 235 being completed.

This section details the configuration elements 231 of the offer system 341. Before an offer 228 is given to the customers (e.g. 111 and 112), the offer 228 may first be configured (e.g. in step 225). Configuration (step 225) may begin with the definition provided by the business 345. The business 345, if able, may define any offer 228 using the existing condition 235 and reward 238 components. They may also define new components, although these may require development in the normal manner to provide them, as would be appreciated by a person of skill in the art. The definition (of offer 228) may include a short offer code, a long offer code, conditions, and rewards. The short offer code may be, for example, a two character code in the format AN (alpha character and number character), e.g., A1. This code may define the offer 228 and may form the driving component of the offer system 341. System 341 may recognize when to apply offer 228, what the conditions 235 are, and what the reward 238 is, all from the short offer code.

The long offer code may be a ten character code in the format AAANNAAANN, e.g., RTA13-ZOC99. This code may be used, at least in part, as a tool to identify the source of the offer 228, which may be done, for example, via the first two characters. The third and fourth characters may be the short offer code, whilst the remaining characters may identify such things as time of the offer 228, location, etc. Other arrangements would be apparent to a person of ordinary skill in the art. The conditions 235 may need to be defined in terms of actions the customer (e.g. 111) takes. In some embodiments there can be more than one condition 235, and they can be AND conditions or OR conditions. For example: “open an account AND trade 3 times OR deposit $5,000 cash OR transfer $5,000 in shares.” Each action may also have a time period for completion. This may be an absolute date (e.g. by Dec. 31, 2003), or a relative period (e.g., “within 30 days”). The offer 228 rewards may be defined in terms of one or more rewards 238 the customer (e.g. 111) receives if all the conditions 235 are met. Depending on the reward 238 itself, any parameters of the reward 238 may also be defined. For example, a cash reward 238 may need to have an amount defined. Once these elements are provided, the offer 228 may be configured (e.g. in step 225).

The offer 228 itself may be a static piece of data that in some embodiments will not be altered once configured (in step 225). However, in order to expire an offer 228 in urgent circumstances, the offer expiration date may be brought forward. In addition, any processes based on the offer 228 may use this piece of static data to determine expiration dates, conditions 235, and rewards 238, and to generally check the validity of the offer 228.

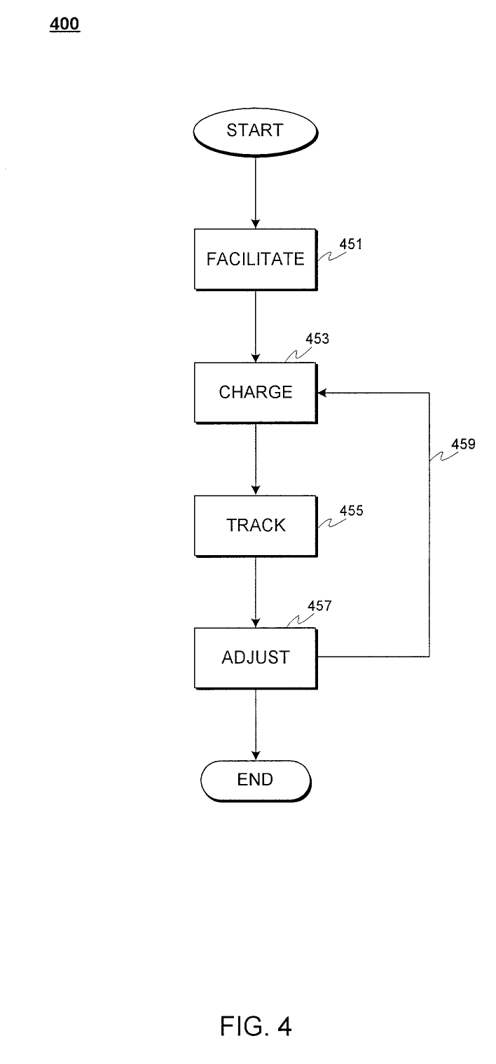

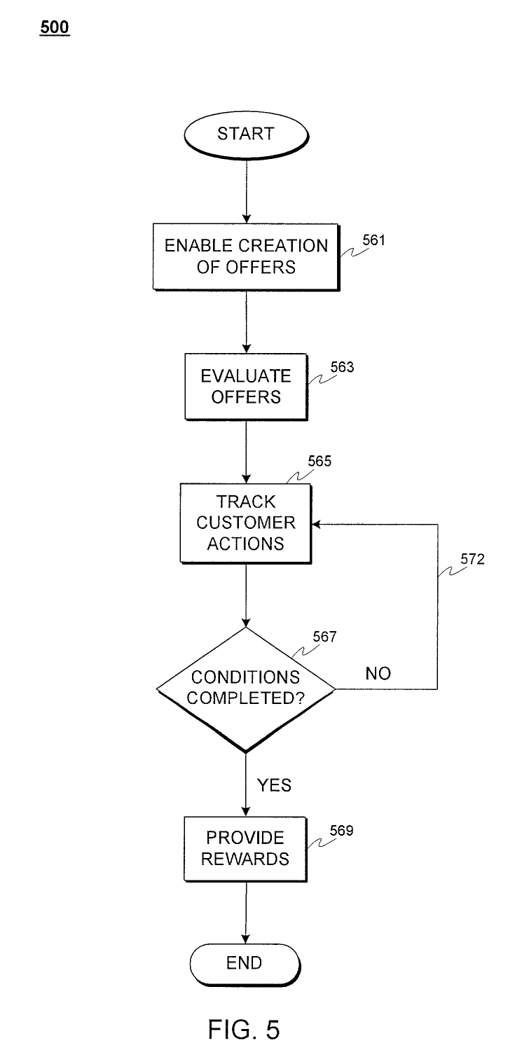

FIGS. 4 and 5 illustrate methods and method steps in accordance with various exemplary embodiments of the present invention. One or more of the steps illustrated in FIG. 4 and FIG. 5 may be implemented via a computer (e.g. processor 101 and/or storage 103) and may be automatic. On the other hand, some steps may be performed manually. Accordingly, FIG. 4 illustrates method 400 of facilitating, for example, trading (e.g. via trader system 343 shown in FIG. 3). As used herein, facilitating may include accommodating, and facilitating may include managing. For instance, method 400 may provide a service and/or structure that allows customers (e.g. 111, 112, and 113) to trade with others. Method 400 may, for example, reward (e.g. provide a reward 238) frequent trading (e.g. via trader system 343). Method 400 includes facilitating (step 451), which may involve using a computer (e.g. processor 101 and/or storage 103 as illustrated in FIG. 1). The facilitating (e.g. step 451) may be, for instance, facilitating trading (e.g. via trader system 343). As an example, trader system 343 may provide the service or facilitate (step 451) customers (e.g. 111, 112, and 113) buying and selling stock in various companies via the Internet (one embodiment of network 110).

Method 400 may also involve charging (step 453), for instance, a fee or commission, for facilitating (e.g. in step 451), for example, the trading (e.g. via trader system 343). Method 400 may further include tracking (step 455), for example, the facilitating (step 451), which may also involve using a computer (e.g. processor 101 and/or storage 103). In other words, for each customer (e.g. 111) system 105 may store information regarding what offers 228 have been created or configured (e.g. in step 225), what actions the customer (e.g. 111) has taken that may satisfy or be relevant to the conditions 235 of each offer 228, etc. For instance, system 105 may maintain a database for each customer (e.g. 111), and may record in the database each time the customer (e.g. 111) makes a trade (e.g. via trader system 343).

Method 400 may even further include adjusting (step 457), for example, the commission (e.g. charged in step 453). Adjusting may include changing, for instance, lowering or increasing what is charged. For instance, the commission may continuously change as the quantity of trading changes, or several different commission rates may be available for different ranges of quantities of trading, and the commission may change only when the quantity of trading changes from one range to another. The step of adjusting (step 457) may occur via link 459, and may be at the time the commission is charged (e.g. in step 453). In other words, the commission (charged in step 453) may be adjusted (in step 457, e.g. for customer 111) and communicated via link 459, by the time the next facilitating (in step 451) occurs (e.g. for the same customer 111) or within a particular amount of time (e.g. overnight), that may be less than a typical interval between times that a customer typically uses the service (e.g. of facilitating in step 451). The adjusting (step 457) may be a reward 238, (or may be the withdrawal of a reward, as the case may be) and may be based, for instance, on whether conditions 235 are met (e.g. as determined in loop 234). The step of adjusting (step 457) may be based, for instance, on the quantity (e.g. in dollar value or number of trades) of trading (e.g. via trader system 343) within a preceding period of time, (e.g. for the same customer 111). The commission (e.g. charged in step 453) may, for instance, be reduced per trade when there is an increase in the quantity of trading (e.g. for the same customer 111 via trader system 343).

In other embodiments of method 400, other activities may be facilitated (in step 451), charging schemes other than commissions may be employed (in step 453), and/or other activities may be tracked (in step 455). But adjustments may still be made (in step 457), to what is charged (in step 453), and the adjustment (of step 457) may be delivered via link 459.

FIG. 5 illustrates still another exemplary method 500, in accordance with the present invention, that may, for example, facilitate trading (e.g. via trader system 343). In such embodiments, method 500 may, as an example, reward frequent trading (e.g. via trader system 343) and may be computer implemented. Method 500 may include enabling (step 561) the creation of offers (e.g. 228) and may be configured to enable offers (e.g. 228) having no conditions, one condition (e.g. condition 235), a plurality of conditions, or may be configured to enable offers with any range of number of conditions (e.g. 235). In other words, method 500 may allow or enable offers to be created that have various numbers of conditions (e.g. 235). As used herein, enabling offers (e.g. 228) means allowing offers (e.g. 228) to be used without making changes in the structure of the system (e.g. 105 or 341), for example, allowing the offers (e.g. 228) to be used without the need to edit computer source-code. As used herein, enabling the creation of offers (e.g. offers 228, step 561) means allowing offers (e.g. 228) to be added to the system (e.g. 105 or 341) without making changes in the structure of the system (e.g. 105 or 341), for example, allowing the offers (e.g. 228) to be added and used without the need to edit computer source-code. Enabling (step 561) the creation of offers (e.g. 228) may include configuring (e.g. step 225) offers (e.g. 228) (and vice versa). In addition, method 500 may enable (e.g. in step 561) offers (e.g. 228) having one reward (238), a plurality of rewards, or both such types of offers (e.g. 228).

Method 500 may further include evaluating (step 563) the offers (e.g. 228), which may include considering any conditions (e.g. 235) and/or considering any rewards (e.g. 238). In the exemplary embodiment of a trader system (e.g. 343), the step of evaluating offers (step 563) may include favoring more frequent trading (e.g. via trader system 343). In other words, offers 228 may be selected, given preferential treatment, or facilitated that encourage more-frequent trading, such as offers 228 that provide rewards 238 when a particular number of trades are performed (e.g. within a particular amount of time). Similarly, offers 228 may be selected, given preferential treatment, or facilitated that provide rewards 238 that include, for example, free trading or reduced commissions for trading. Such preferential treatment may include, for example, for purposes of comparing offers 228, assigning a value to trading that is above the actual commission received when trading is a condition (e.g. 235), and assigning a value to trading that is below the actual commission received when trading is a reward (e.g. 238).

Method 500 may also include tracking (step 565) the actions of customers (e.g. 111, 112, and 113), which may involve storing (e.g. in storage 103) information regarding the actions of the customers (e.g. 111, 112, and 113) regarding the conditions (e.g. 235) of the offers (e.g. 228). Step 565 may be similar or identical to step 455 of FIG. 4. Method 500 may further include determining (step 567) whether the customers (e.g. 111, 112, and 113) have completed the conditions (e.g. 235).

Step 567 may be similar or identical to loop 234. If conditions (e.g. 235) are not completed (e.g. as determined in step 567), then customer (e.g. 111) actions may continue to be tracked (step 565) via loop 572, until the conditions (e.g. 235) are met. In many embodiments of the present invention, customer (e.g. 111) actions may continue to be tracked even after the conditions (e.g. 235) are met.

Method 500 may even further include allocating or making the rewards (e.g. 238) available (step 569) to the customers (e.g. 111, 112, and 113), which may be, for example, by the next day from when the conditions (e.g. 235) for the rewards (e.g. 238) were completed. For instance, in the example of a trader system 343, the commission charged for trading may be reduced (the reward 238) when a particular number of trades have been performed within a particular time (the conditions 235).

Looking now at various examples of combinations of structure and method steps, an exemplary embodiment of the present invention consists of an offer system (e.g. 105 or 341, shown in FIG. 1 and FIG. 3 respectively) that includes a processor 101 and a storage device 103 (shown in FIG. 1). The processor 101 and the storage device 103 (or, for example, system 105) may be configured to enable a plurality of offers (e.g. 228 shown in FIG. 2), which may have at least one condition (e.g. 235) and at least one reward (e.g. 238). Being configured to enable offers (e.g. 228) may include being configured to enable the creation of offers (step 561 of FIG. 5), or being configured to configure offers (step 225 of FIG. 2). But, as used herein, being configured to enable offers (e.g. 228) does not necessarily include being configured to create the offers. Thus, offers 228 may originate externally to the system (e.g. 105 or 341). Offers 228 may be created by or originate from business 345.

The system (e.g. 105 or 341) may enable offers (e.g. 228) with no conditions, offers (e.g. 228) with only one condition (e.g. 235), offers (e.g. 228) with a plurality of conditions, (e.g. 235) offers (e.g. 228) with only one reward (e.g. 238), offers (e.g. 228) with a plurality of rewards (e.g. 238), or some combination thereof (e.g. of conditions 235 and rewards 238). In one exemplary embodiment, processor 101 and storage 103 are configured to enable offers 228 having only one condition 235, enable offers 228 having a plurality of conditions 235, enable offers 228 having only one reward 238, and enable offers 228 having a plurality of rewards 238. As used herein, this means that in this particular embodiment, processor 101 and storage 103 is able to accommodate and manage offers 228 with any of these four characteristics.

The system (e.g. 105 or 341) may track actions of the customers (e.g. 111, 112, and 113) (e.g. in loop 234 shown in FIG. 2, step 455 shown in FIG. 4, or step 565 shown in FIG. 5), including activities regarding one or more of the conditions (e.g. 235). Thus, system (e.g. 105 or 341) may track actions of the customers (e.g. 111, 112, and 113) to determine whether the conditions (e.g. 235) have been met (e.g. which may be similar or identical to step 567). The system (e.g. 105 or 341) may also determine whether the conditions (e.g. 235) have been met and allocate one or more rewards (e.g. 238) in accordance with one or more offers (e.g. 228) when at least one of the conditions (e.g. 235) has been met. As described herein, the system (e.g. 105 or 341) may enable, as an example, offers 228 that have a reward 238 that includes facilitating trading.

In various further embodiments, the system (e.g. 105 or 341) may be configured to accommodate mandatory conditions (e.g. 235), optional conditions (e.g. 235), or both, which are described in more detail above. A commission may be charged (e.g. in step 453 of FIG. 4) for the facilitating (e.g. step 451) trading (e.g. via trader system 343), and the reward (e.g. 238) may include lowering the commission (e.g. of step 453). The trading (e.g. facilitated in step 451, e.g. via trader system 343) may include transferring ownership of at least part of at least one company, which may include buying or selling stock. In other embodiments, the trading may include buying and selling stock from may different companies, or buying and/or selling other things such as shares in mutual funds, bonds, currency (of various countries), commodities, futures, new or used goods, real estate, insurance, mortgages, energy, art, jewelry, patents, information, tickets, services, etc., or loaning or borrowing money.

For embodiments in which a commission is charged (e.g. a flat fee for each trade or a percentage of the monetary value of the trade), the system (e.g. 105 or 341) may be configured to lower the commission (e.g. charged in step 453) within 24 hours of when the conditions (e.g. 235) are met. For instance, the system (e.g. 105 or 341) may check (e.g. loop 234) once a day (e.g. at night) to determine whether conditions 235 have been met, after which (e.g. immediately after) rewards 238 may be allocated (e.g. lowing commissions for customers who have exceeded a particular quantity of trading (e.g. in number or value of trades). The condition (e.g. 235) may include a quantity of trading (e.g. facilitated in step 451) within a preceding period of time, such as, for example, 90-days. In some embodiments, the system (e.g. 105 or 341) may be configured to evaluate a plurality of offers (e.g. in step 563 shown in FIG. 5, e.g. offers 228) for one or more customers (e.g. 111, 112, and/or 113), which may include determining the best offer (e.g. 228) under the circumstances (e.g. which conditions 235 have been met) for each customer (e.g. 111, 112, and/or 113). The best offer may be best from the customer's perspective, for instance, the reward with the greatest monetary value (e.g. the lowest commission). The system (e.g. 105 or 341) may then, as an example, allocate (e.g. in step 569) one or more rewards (e.g. 238) in accordance with the best offer (e.g. 228) for one, more, or each customer (e.g. 111,1 12, and/or 113).

The system (e.g. 105 or 341) may be configured to communicate with at least some of the customers (e.g. 111, 112, and/or 113) via the Internet, cellular telephony, and/or the like. In other words, network 110 (shown in FIG. 1 and FIG. 3) may include, for example, the Internet, a cellular or wireless telephone network, or both.

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or“ critical”.

In addition, modifications may be made to the disclosed embodiments without departing from the scope of the invention. The scope of the invention is therefore not limited to the disclosed embodiments but is defined by the appended claims. In other words, other variations and modifications of the present invention will be apparent to those of ordinary skill in the art, and it is the intent of the appended claims that such variations and modifications be covered. The particular values and configurations discussed above can be varied, are cited to illustrate particular embodiments of the present invention, and are not intended to limit the scope of the invention. It is contemplated that the use of the present invention can involve components having different characteristics as long as the elements of at least one of the claims below, or the equivalents thereof, are included.

What is claimed is:

1. An offer system including a processor and a storage device, the system being configured to:
enable a plurality of offers, at least some of the offers having at least one condition and at least some of the offers having at least one reward,
track actions of the plurality of customers, the actions including activities regarding the at least one condition,
determine whether the at least one condition has been met, allocate the at least one reward in accordance with at least one of the offers when the at least one condition has been met, and
enable offers having a reward comprising facilitating trading.

2. The system of claim 1, the system being configured to accommodate both mandatory and optional conditions.

3. The system of claim 1, a commission being charged for the facilitating trading, the at least one reward comprising lowering the commission.

4. The system of claim 3, the trading including transferring ownership of at least part of at least one company.

5. The system of claim 3:
the system being configured to lower the commission within 24 hours of when the at least one condition is met, and
the at least one condition comprising at least a quantity of trading within a preceding period of time.

6. The system of claim 1 configured to:
evaluate a plurality of offers for at least one of the plurality of customers, including determining a best offer under the circumstances for the at least one of the plurality of customers; and
allocate the at least one reward in accordance with the best offer for the at least one of the plurality of customers.

7. The system of claim 1 configured to communicate with at least some of the customers via the Internet.

8. The system of claim 1 configured to communicate with at least some of the customers via cellular telephony.

9. A computer implemented method of facilitating trading that rewards frequent trading, the method comprising in any order at least the steps of:
facilitating trading, said facilitating including using a computer;
charging a commission for said facilitating;
tracking said facilitating; and
adjusting the commission, at the time the commission is charged, based on at least the quantity of trading within a preceding period of time, said adjusting including at least changing the commission per trade with a change in the quantity of trading.

10. A computer implemented method of facilitating trading that rewards frequent trading, the method comprising in any order at least the steps of:
enabling the creation of offers;
the offers having at least one condition, and
the offers having at least one reward;
evaluating the offers, said evaluating including at least:
considering any conditions,
considering any rewards,
favoring more-frequent trading;
tracking the actions of customers, said tracking comprising at least storing information regarding the actions of the customers regarding conditions;
determining whether at least one of the customers has completed the conditions; and
making available at least one reward at least by the next day from when the conditions for the reward are completed.
